(19) United States
(12) Patent Application Publication
(10) Pub. No.: US 2014/0269142 A1
(43) Pub. Date: Sep. 18, 2014

(54) Concrete Mixing Device

(71) Applicant: Weiler, Inc., Knoxville, IA (US)

(72) Inventor: Tate Z. Huizer, Pella, IA (US)

(21) Appl. No.: 13/799,830

(22) Filed: Mar. 13, 2013

(51) Int. Cl. B28C 5/42

(52) U.S. Cl. CPC B28C 5/421
USPC 366/2; 366/60

(57) ABSTRACT

A concrete mixing apparatus having a truck, an engine, a frame, and a drum rotatably associated with the truck automates the need for increasing the throttle on the primary power source to increase speed of the secondary system so that the speed of rotation of the drum may be increased to a desired level. The apparatus is equipped to set speed of rotation of the drum, count rotations of the drum and set time of rotation of the drum based on a signal sent from a sensor. The truck may include a push button operation for selecting “mix” or “maintain” or “pour” or some other function which selection automatically causes the apparatus to rotate the drum at a predetermined speed and/or for a predetermined time.

### FIELD OF THE INVENTION

The present invention relates to a transport vehicle, such as a truck, equipped with a drum designed for mixing concrete and maintaining concrete ready for pouring while transporting the concrete to a worksite and then delivering the concrete.

### BACKGROUND

Concrete is made my mixing cement with sand, ash gravel or other material and water. It must be mixed with a certain level of agitation and then maintained until it is poured. The time for mixing and maintaining is typically desired to be less than 90 minutes in order to keep the concrete from setting before it is poured. To meet the relatively short time window, trucks and other transport vehicles have been designed to transport and mix concrete simultaneously. Maintaining the mixture requires a lower level of agitation than mixing it. Mixing too fast or too slow, or maintaining at rates of mixture too fast or slow results in sub-par quality concrete with short durable life. When the concrete is ready, it is poured into a bed prepared for its delivery.

Often a drum is mounted on a frame on a truck bed in such a way that the drum may be rotated. The drum may be turned in either direction; a first direction tumbles the mixture within the drum while the opposite direction, in combination with the internal contours of the drum, employs gravity and internal flights to cause the concrete to pour out of one end of the drum. The truck's engine is typically associated with a secondary system. The secondary system may be a hydraulic system or pneumatic system, electrical or other similar system. The engine is associated with the secondary system usually by a power take off for transforming rotational movement to the secondary system to increase the secondary system's speed. Where the secondary source is hydraulic, an increase in engine speed results in an increase of maximum available flow of hydraulic fluid through the pump. Other means may be used to transform the power provided by the engine to pneumatic, hydraulic pressure, or to electrical or other power. The secondary system is associated with mechanics known in the art that rotate the drum in either of two directions. Controls mounted on the truck body, frame, and/or in its cab associated with the mechanics for rotating the drum allows an operator to use levers or buttons to start, stop, or reverse the rotation of the drum, and to increase or decrease the speed of the rotation of the drum.

During transportation, concrete may be mixed or maintained if already mixed. Alternatively, while the truck is immobile, concrete may be mixed or maintained or may also be poured. The truck may also be moved slowly while concrete is poured in order to obtain proper distribution. In each of these cases, the drum is typically rotated at specific ranges of RPMs.

The operator is able to adjust the direction of rotation of the drum and the speed of rotation of the drum by employing the controls described previously. In actual practice, in order to speed the rate of rotation, the operator uses the controls to call for increased rotation but also often has to manually adjust the throttle to speed up the engine in order to provide more speed to the secondary system so that the rotational speed can be increased to the desired rate. This two step process often becomes a three step process when the operator goes back and decreases the engine speed once the desired rotational speed of the drum has been reached, but many times this adjustment does not occur. If it does not, then the engine runs at higher speed than necessary and fuel costs increase.

A relatively tricky aspect of concrete mixing also relates to the speed of rotation and to the number of rotations at that speed. Too fast and/or too many rotations will result in excess wear on the drum or decreases the amount of entrained air which results in concrete that is weaker, perhaps with less durability and other negative effects. Too slow or too few rotations will produce concrete that is not uniform due to not being thoroughly mixed. Some concrete trucks are equipped with rotation counters to assist an operator to determine when the correct number has been reached; thereafter, the operator is required to reduce the speed of the engine and drum to maintain the concrete without overmixing it. However, in reality, many operators simply leave the engine at speed (and the RPM's) and do not reduce it thereby wasting fuel. Further, it is not unusual for an operator to completely ignore the RPM counter or pay very little attention to it which results in over or under mixing the concrete, unnecessary wear on the fins in the drum, and wasted fuel.

During load out of concrete, the operator will be required to position the truck and set its brakes; get out and set the speed of rotation of the drum, and perhaps go back to adjust the throttle to obtain appropriate engine speed. This routine may be necessary more than once during load out. Or, although the engine speed could be reduced as the load is poured and less power is needed, the operator does not adjust the engine speed and may not adjust the rotational speed of the drum once again resulting in wasted fuel and wear on parts. What was needed was a means to manage the throttle on the engine relative to the desired RPMs of the drum and the speed or output of the secondary system. What was also needed was a way to reduce the negative effects of human error or inattentiveness relative to speed and time and/or number of the drum's rotation.

### SUMMARY

An objective of the present invention is to reduce wear and tear on the drum and fins inside the drum;

Another objective of the present invention is to reduce fuel consumption related to overmixing or over speeding an engine when no longer necessary to reach desired RPM's.

Another objective of the present invention is to reduce the incidence rate of human error related to overmixing, undermixing, or maintaining at drum rotation rates that are too high or too low, all of which effect the quality of the concrete produced and its durability.

### BRIEF DESCRIPTION OF THE DRAWINGS

Example embodiments are described in detail below with reference to the attached drawings figures:

FIG. 1 is a drawing of a vehicle comprising the present invention.

FIG. 2 is a flowchart of the method of operation of the mixing device.

FIG. 3 shows the display and controls for one embodiment of the mixing device.

FIG. 4 is a flowchart showing a second mode of operation of the mixing device.

### DETAILED DESCRIPTION

The present invention comprises a method and an apparatus for accomplishing the method. Specifically, the invention comprises a method for governing the speed of the rotation of a drum on a concrete truck wherein the concrete truck comprises; a primary power source, (typically an engine) 10, a secondary system 23, a throttle 12, a drum 14, a set of controls for controlling the speed of rotation of the drum 16; means for rotating said drum 18 comprising the secondary system 23; a predetermined rate of rotation 15 of said drum 14 selected by said set of controls 16; a sensor 20 on said drum 14 for sensing of the rate of rotation of said drum and sending a corresponding signal; a receiving means for receiving said signal from said sensor and adjusting the throttle of said engine 22; and means for adjusting (by setting, increasing or decreasing) the speed or level of operation of the secondary system 23 and, in turn, said means for rotating said drum 18 and a frame 26 upon which the drum 14 is rotatably mounted (shown at FIG. 1). The method shown as a diagram at FIG. 2 comprises one of several modes of operation. A first such mode of operation comprises setting at least one of said set of controls 16 (see FIG. 3) to a predetermined rate of rotation 15 of the drum 14 and activating the control 16; said receiving means 22, receiving a signal from the sensor 20 and comparing the speed of the drum's 14 rotation with the predetermined rate of rotation 15 set by at least one of said controls 16, employing said means for adjusting the speed of the secondary system 23 and the means for rotating said drum 18 and comparing the level of operation of said secondary system 23 to a maximum (or minimum) level 30 said means for receiving said signal 22 adjusting the throttle 12 of the engine 10 to increase (or decrease) speed of the engine 10 which, in turn, increases (or decreases) the speed or other factor related to power of said secondary source 23 and means for rotating said drum 18 until said predetermined rate 15 equals the speed of rotation and thereafter adjusting the throttle 12 to maintain said rate of rotation 19 as determined by the setting of the control 16.

A second mode of operation similar to the first, further includes a means to set time of rotation 30 and/or number of rotations 32 at a given rate of drum rotation 20. Said means to set time of rotation 30 and/or number of rotations 32 may be integral with said set of controls 16 or separate therefrom, and is associated with said means for rotating said drum 18. In another embodiment, means to set time for rotation 30 or number of rotations 32 comprises means to receive 22 a signal from said sensor 20 for each rotation of said drum 14 or, to indicate beginning of rotation. In either embodiment, upon meeting the time for rotation 30 or number of rotations 32, said means for receiving 22 comprises means for receiving a signal or command indicating said set time or number of rotations has been met 40, said means for receiving said signal 40 then adjusting said throttle 12 as needed to provide the required speed to said means for rotating said drum 18 in order to meet the required speed of rotation or the number of required rotations. Said means for rotating said drum 18 comprises said secondary system 23 which may comprise a pneumatic, hydraulic, electric system, further comprising or optionally including a drive unit, said drum 14, and a frame 42. Means for selecting a desired speed of rotation 16, or time for rotation 30, or number of rotations 32 e.g. a dial, digital read out with toggle switch, movable levers, etc. clock to set start and end, push button, or dial to select amount of time to rotate, a counter to track number of rotations, all associated with said means for receiving 22 and processing said signal from the sensor 20 and in communication with said throttle 12 and said means for rotating said drum 18, means for receiving and processing said signal 22 from the sensor 20 to determine whether speed has met the desired rate of rotation and means to determine whether said means for rotating said drum 18 and to change the throttle 12 position to speed up or slow down the primary power source 10 in accordance with the needs of the secondary source 23 (and means for rotating said drum 18) to meet the desired speed of rotation, and/or the desired time of rotation and/or the number of rotations 32.

Means for receiving and processing a signal from the sensor, means for counting rotations, means for determining whether speed has met the desired speed and whether the level of operation of said secondary source 23 is at its maximum (or minimum) level 30 may be controlled by a single computer processing unit, or by separate sensors and multiple processing units.

Selecting the appropriate number of rotations and/or time for the drum to rotate may be made as simple as push buttons labeled by the function to be accomplished. The user simply selects the button labeled “mix” or “maintain” or “pour”, etc., and one or several computer processing units process the signal, set the appropriate number of rotations and time for rotation, actuate the throttle on the engine in accordance with the selected function and said means to rotate said drum, and employs said means for receiving to receive signals from the sensor associated with said drum, said signal indicative of the number of rotations and speed of rotations. As required, said throttle is increased or decreased in response to the comparisons of actual and desired speed, and the maximum operating level and current operating level and/or time elapsed. This push button, or single command operation, reduces human error and conserves fuel while also reducing wear and tear on the track, drum, fins and mechanics.

The invention has heretofore been described with accuracy and specificity but it should be recognized that numerous other embodiments and modifications may be made which come within the spirit and scope of the present invention. For example, the push button aspect my be accomplished via switches or dials or levers which can be pre-set by a user or supervisor. The sensor associated with the drum may be physically present on the drum, associated with the drum via the powertrain or may be a detector located near the drum. Means to rotate the drum, the secondary system, may be any device that can translate rotational power from the engine to power necessary to turn the drum. The invention, therefore, may be accomplished in several ways which are covered by the claims which follow even where every detail may not be overtly claimed:

The invention claimed is:

1. A concrete mixing and transporting machine comprising:
a) a truck comprising a drum and a throttle, associated with an engine;
b) means for selecting a desired rotational speed for said drum;
c) means for rotating said drum comprising a secondary system and a maximum level of operation of said secondary system for a given speed of said engine; and
d) means for receiving and processing a signal from a sensor for sensing the speed of the drum;
e) means to compare the speed of the drum to the desired rotational speed and to compare said maximum level of operation of said means for rotating said drum to a current level of operation, said means for receiving and processing adjusting the throttle to effect the speed of the engine to provide required speed to said secondary system for rotating said drum at a rate of rotation within a specified range.

2. A concrete mixing and transporting machine comprising:
a truck having an engine and a throttle associated with said engine;
a drum associated with means for rotating said drum, a sensor for sensing the speed of rotation of said drum and sending a corresponding signal;
means for selecting a desired speed of rotation of said drum and means for receiving said signal, wherein said means for receiving said signal further comprises means to compare said signal with a desired speed of said drum and adjust the throttle associated with the engine to cause said speed of rotation to comport with said desired speed of the drum.

3. The invention of claim 2 further comprising a secondary system associated with said means for rotating said drum, wherein when said speed of rotation is less than said desired speed and said secondary system is operating above said maximum level of operation, said means for receiving said signal adjusts the throttle to increase the speed of the engine until said desired speed of rotation is met.

4. A method for conserving fuel while operating a concrete truck, said truck comprising a drum rotatably associated with said truck; a throttle associated with a primary power source; means for receiving a signal; and means for rotating said drum, said means comprising a secondary system having a maximum level of operation, said method comprising setting a desired speed of rotation for said drum, and, receiving a signal from a sensor associated with said drum, wherein said signal indicates a speed of rotation of said drum, and comparing the speed of rotation with the desired speed, and comparing the level of operation of the secondary system with said maximum level and adjusting the level of operation of the secondary system to comport with the desired speed of rotation of the drum.

5. A method for operating a concrete truck, said truck comprising an engine, a throttle, means for rotating a drum, said means for rotating comprising a propulsion system powered by the engine, and a maximum level of operation, said method comprising:
a) setting a desired speed of rotation for the drum;
b) determining a current speed of rotation of said drum;
c) comparing the current speed to the desired speed of rotation of said drum;
d) comparing the maximum level of operation of said means to rotate said drum to the current level of operation;
e) determining if the current speed has reached desired speed and maximum level of operation has been exceeded;
f) actuating said throttle to increase the speed of said engine if the current speed of rotation of the drum does not equal or exceed the desired speed and the current level of operation has exceeded the maximum level of operation of said means for rotating the drum.

6. A concrete truck and method for operating the concrete truck wherein said truck comprises a primary power source, a drum, and a means for rotating said drum said means for rotating comprising a propulsion system powered by the primary power source, said method comprising: comparing a current speed of rotation of the drum with a desired speed of rotation, and increasing the speed of said primary power source if the speed of rotation of the drum is less than the desired speed.

7. The concrete truck of claim 6 further comprising a single-action means to cause said propulsion system to rotate said drum at a pre-set speed of rotation.

8. The concrete truck of claim 6 further comprising a single-action means to cause said propulsion system to rotate said drum for a pre-set amount of time.

9. The concrete truck of claim 6 wherein said single-action means causes said propulsion system to rotate said drum for a pre-set amount of time and a pre-set number of rotations.
